(19) United States
(12) Patent Application Publication
(10) Pub. No.: US 2022/0308912 A1
(43) Pub. Date: Sep. 29, 2022

(54) SETTING CHANGING DEVICE, SETTING CHANGING METHOD, AND COMPUTER READABLE MEDIUM

(71) Applicant: Mitsubishi Electric Corporation, Tokyo (JP)

(72) Inventors: Ryosuke YAMAMOTO, Tokyo (JP); Akio IDEHARA, Tokyo (JP); Masayuki KIRIMURA, Tokyo (JP)

(73) Assignee: Mitsubishi Electric Corporation, Tokyo (JP)

(21) Appl. No.: 17/840,941

(22) Filed: Jun. 15, 2022

Related U.S. Application Data
(63) Continuation of application No. PCT/JP2020/004637, filed on Feb. 6, 2020.

(51) Int. Cl. G06F 9/455

(52) U.S. Cl. CPC G06F 9/45558; G06F 2009/4557

(57) ABSTRACT

A log acquisition unit (111) acquires an activity log concerning an information processing device in which a guest OS (Operating System) operates on a hypervisor, the activity log including a monitoring object log on a monitoring object item and a factor candidate log on each of a plurality of factor candidate items that influence the monitoring object item. A factor identification unit (112) identifies a factor candidate item for which a difference between a value indicated by the factor candidate log in a normal state in which a value indicated by the monitoring object log is within a criterion range and a value indicated by the factor candidate log in an abnormal state in which a value indicated by the monitoring object log is out of the criterion range exceeds a threshold. A setting changing unit (113) decides a setting item, assigned to the identified factor candidate item, as a changing object item.

### CROSS REFERENCE TO RELATED APPLICATIONS

This application is a Continuation of PCT International Application PCT/JP2020/004637, filed on Feb. 6, 2020, which is hereby expressly incorporated by reference into the present application.

### TECHNICAL FIELD

The present disclosure relates to a setting technique for a guest OS (Operating System) that operates on a hypervisor.

### BACKGROUND ART

There is an embedded appliance that makes control system processing and information system processing compatible. In the embedded appliance, RTOS (Real Time Operating System) that is a control system OS (Operating System) and GPOS (General Purpose Operating System) that is an information system OS are simultaneously operated with use of a hypervisor in order to make the control system processing and the information system processing compatible.

The hypervisor assigns hardware such as CPU (Central Processing Unit), memory, or I/O (Input/Output) device to each of guest OSs. In the embedded appliance described above, the guest OSs are the RTOS and the GPOS.

An amount of hardware resources required for each of the guest OSs depends on applications that operate on the guest OS and may fluctuate dynamically. Therefore, it is difficult to manually assign the hardware resources.

Patent Literature 1 discloses a technique that automatically assigns hardware to each of guest OSs. According to Patent Literature 1, determination of the amount of hardware resources required for each of the guest OSs and the assignment of the hardware resources to the guest OS are carried out through checking of load status such as CPU load and memory load in the guest OS.

### CITATION LIST

### Patent Literature

Patent Literature 1: JP 2002-202959

### SUMMARY OF INVENTION

### Technical Problem

Real-time performance is required for the RTOS. Thus a guest OS for which the real-time performance is required may operate on the hypervisor.

In the technique disclosed in Patent Literature 1, however, only items linked to hardware, such as CPU utilization linked to a CPU and memory usage linked to a memory, are checked as the load status of the guest OS. In the technique disclosed in Patent Literature 1, accordingly, there is a fear that the real-time performance of the guest OS may be impaired.

The present disclosure aims at enabling attainment of adequate setting of a hypervisor in which the real-time performance of a guest OS is considered.

### Solution to Problem

A setting changing device according to the present disclosure include a log acquisition unit to acquire an activity log concerning an information processing device in which a guest OS (Operating System) operates on a hypervisor, the activity log including a monitoring object log on a monitoring object item and a factor candidate log on each of a plurality of factor candidate items that influence the monitoring object item;

a factor identification unit to identify a factor candidate item for which a difference between a value indicated by the factor candidate log in a normal state in which a value indicated by the monitoring object log acquired by the log acquisition unit is within a criterion range and a value indicated by the factor candidate log in an abnormal state in which a value indicated by the monitoring object log acquired by the log acquisition unit is out of the criterion range exceeds a threshold; and

a setting changing unit to decide a setting item, assigned to the factor candidate item identified by the factor identification unit, as a changing object item.

### Advantageous Effects of Invention

In the present disclosure, the value of the setting item assigned to a factor candidate item is changed for a factor candidate item whose difference in the value indicated by the factor candidate log between the case where the value indicated by the monitoring object log for the monitoring object item is within the criterion range and the case where the value is out of the criterion range exceeds the threshold. Thus the adequate setting of the hypervisor in which the real-time performance of the guest OS is considered can be attained.

### BRIEF DESCRIPTION OF DRAWINGS

FIG. 1 is a configuration diagram of a setting changing system 1 according to Embodiment 1.

FIG. 2 is a configuration diagram of a setting changing device 10 according to Embodiment 1.

FIG. 3 is a configuration diagram of an information processing device 20 according to Embodiment 1.

FIG. 4 is an explanatory diagram for a monitoring object table 131 according to Embodiment 1.

FIG. 5 is an explanatory diagram for a factor candidate table 132 according to Embodiment 1.

FIG. 6 is an explanatory diagram for a result table 133 according to Embodiment 1.

FIG. 7 is a flowchart illustrating general operation of the setting changing system 1 according to Embodiment 1.

FIG. 8 is a flowchart of a setting changing process according to Embodiment 1.

FIG. 9 is a configuration diagram of the setting changing device 10 according to Modification 2.

FIG. 10 is a flowchart of an item decision process according to Embodiment 2.

### DESCRIPTION OF EMBODIMENTS

### Embodiment 1

*** Description of Configuration ***

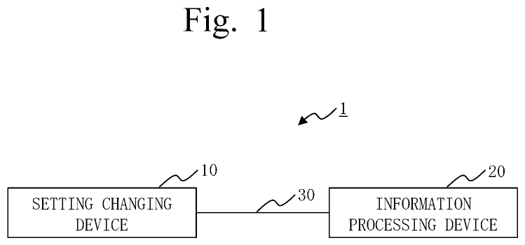

With reference to FIG. 1, a configuration of a setting changing system 1 according to Embodiment 1 will be described.

The setting changing system 1 includes a setting changing device 10 and an information processing device 20. The setting changing device 10 and the information processing device 20 are connected through a transmission path 30.

The setting changing device 10 is a computer to provide setting of a hypervisor that operates on the information processing device 20. The information processing device 20 is a computer on which the hypervisor operates and in which a plurality of guest OSs operate on the hypervisor.

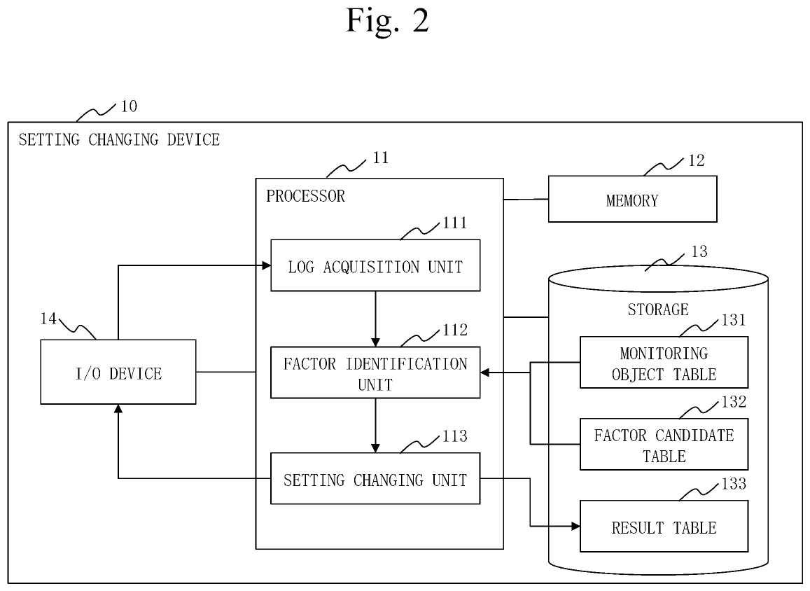

With reference to FIG. 2, a configuration of the setting changing device 10 according to Embodiment 1 will be described.

The setting changing device 10 includes a processor 11, a memory 12, a storage 13, and an I/O device 14, as hardware. The processor 11 is connected to other hardware through signal lines in order to control the other hardware.

The setting changing device 10 includes a log acquisition unit 111, a factor identification unit 112, and a setting changing unit 113, as functional components. Functions of the functional components of the setting changing device 10 are implemented by software.

A program that implements the function of each functional component of the setting changing device 10 is stored in the storage 13. This program is read into the memory 12 by the processor 11 and is executed by the processor 11. Thus the function of each functional component of the setting changing device 10 is implemented.

Additionally, a monitoring object table 131, a factor candidate table 132, and a result table 133 are stored in the storage 13.

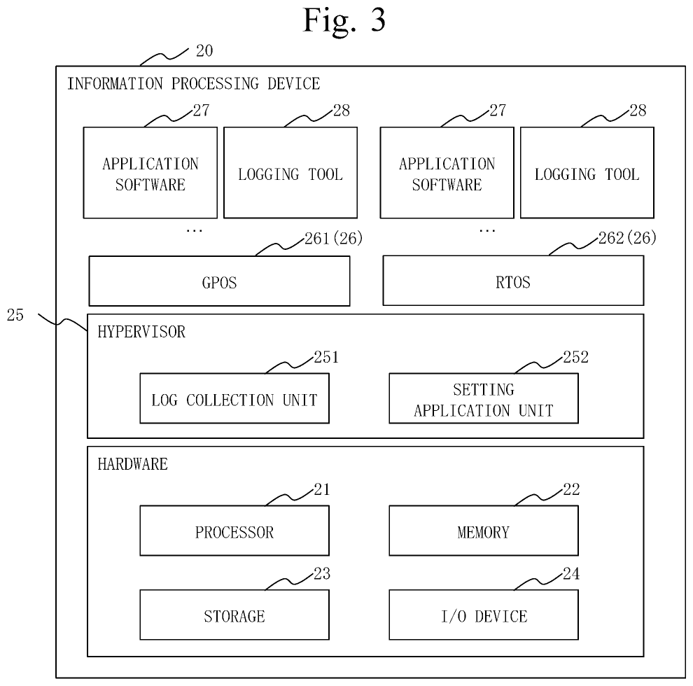

With reference to FIG. 3, a configuration of the information processing device 20 according to Embodiment 1 will be described.

The information processing device 20 includes a processor 21, a memory 22, a storage 23, and an I/O device 24, as hardware.

In the information processing device 20, a hypervisor 25 operates on the hardware and a GPOS 261 and an RTOS 262 that are guest OSs 26 operate on the hypervisor 25. On each of the GPOS 261 and the RTOS 262, one or more pieces of application software 27 and a logging tool 28 operate.

The GPOS 261 is an OS to perform the information system processing and the RTOS 262 is an OS to perform the control system processing. The application software 27 is software to operate when the information processing device 20 is actually operated. The logging tool 28 is a tool to acquire a log indicating states of the OSs and the application software 27.

Incidentally, the application software 27 is software that is commonly provided in the information processing device 20 and has no function concerning the setting of the hypervisor. Accordingly, the setting of the hypervisor to be described below can be carried out even if the information processing device 20 does not include the application software 27.

The information processing device 20 includes a log collection unit 251 and a setting application unit 252, as functional components. In FIG. 3, the log collection unit 251 and the setting application unit 252 are illustrated as functions of the hypervisor 25. The log collection unit 251 and the setting application unit 252, however, are not limited thereto and may be implemented as application software or the like on the guest OSs 26 that are different from the GPOS 261 and the RTOS 262 which operate on the hypervisor 25.

The processor 11, 21 is an IC (Integrated Circuit) to carry out processing. Specific examples of the processor 11, 21 are CPU (Central Processing Unit), DSP (Digital Signal Processor), and GPU (Graphics Processing Unit).

The memory 12, 22 is a storage device to temporarily store data. Specific examples of the memory 12, 22 are SRAM (Static Random Access Memory) and DRAM (Dynamic Random Access Memory).

The storage 13, 23 is a storage device to save data. A specific example of the storage 13, 23 is HDD (Hard Disk Drive). Alternatively, the storage 13, 23 may be a portable recording medium such as SD (registered trademark, Secure Digital) memory card, CF (CompactFlash, registered trademark), NAND flash, flexible disk, optical disk, compact disc, Blu-ray (registered trademark) disk, or DVD (Digital Versatile Disk).

The I/O device 14, 24 is an interface for connection with a device such as a display or a network controller. Specific examples of the I/O device 14, 24 are ports of Ethernet (registered trademark), USB (Universal Serial Bus), and HDMI (registered trademark, High-Definition Multimedia Interface).

*** Description of Operation ***

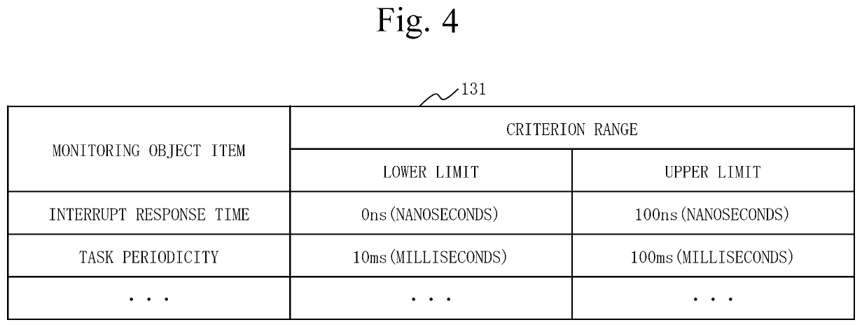

With reference to FIGS. 4 to 8, operation of the setting changing system 1 according to Embodiment 1 will be described.

An operation procedure of the setting changing device 10 according to Embodiment 1 is equivalent to a setting changing method according to Embodiment 1. Meanwhile, a program that implements the operation of the setting changing device 10 according to Embodiment 1 is equivalent to a setting changing program according to Embodiment 1.

The setting changing device 10 changes the setting of the hypervisor 25, based on an activity log of each of the guest OSs 26 that operate on the information processing device 20. A monitoring object log and a factor candidate log are included in the activity log.

The monitoring object log is a log of monitoring object items concerning performance or functions that have to be secured by the information processing device 20. In Embodiment 1, the monitoring object log is a log on monitoring object items that influence the real-time performance of the guest OSs 26. Setting of one or more monitoring object items is carried out.

The factor candidate log is a log on each of a plurality of factor candidate items that are expected to influence at least any of the monitoring object items. In case where a monitoring object item is task periodicity, for instance, items such as the CPU utilization or interruption frequency compose the factor candidate items.

Values and acquisition time of the monitoring object items are included in the monitoring object log. Meanwhile, values and acquisition time of the factor candidate items are included in the factor candidate log. Time synchronization among the guest OSs 26 is fulfilled and thus identical acquisition time represents identical time for the monitoring object log or the factor candidate log acquired from any of the guest OSs 26.

With reference to FIG. 4, the monitoring object table 131 according to Embodiment 1 will be described.

The monitoring object table 131 is a table that is set by an administrator of the information processing device 20 or the like before the operation of the setting changing device 10 is started and a table in which a criterion range is set for each of the monitoring object items.

In FIG. 4, a lower limit and an upper limit are specified as the criterion range. The value of a monitoring object item is within the criterion range in case where the value of the monitoring object item is equal to or greater than the lower limit and equal to or smaller than the upper limit, while the value of a monitoring object item is out of the criterion range in case where the value of the monitoring object item is smaller than the lower limit or greater than the upper limit. In case where the value of a monitoring object item is out of the criterion range, the monitoring object item is an item to be improved.

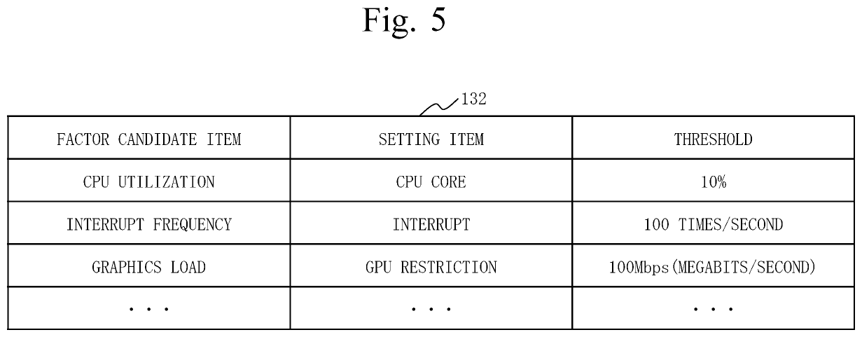

With reference to FIG. 5, the factor candidate table 132 according to Embodiment 1 will be described.

The factor candidate table 132 is a table that is set by the administrator of the information processing device 20 or the like before the operation of the setting changing device 10 is started and a table in which a setting item and a threshold are set for each of the factor candidate items. In Embodiment 1, the setting item is a hardware item that influences the value of the factor candidate item and is a hardware item that can be set by the hypervisor 25. In case where the factor candidate item is the CPU utilization, for instance, the setting item is CPU core assignment. The threshold is a value to be a criterion for determining whether the factor candidate item has influenced the monitoring object items or not.

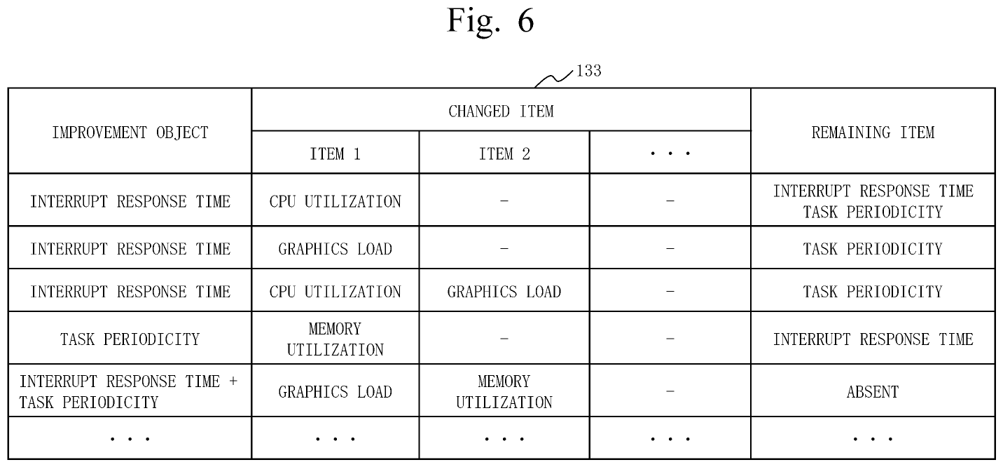

With reference to FIG. 6, the result table 133 according to Embodiment 1 will be described.

The result table 133 is a table in which results of changes in the setting are stored and a table that includes improvement objects, changed items, and remaining items. The improvement objects are the monitoring object items for which improvement has been attempted. The changed items are the setting items that have been changed. The remaining items are the monitoring object items that remain after the changed items are changed and that are to be improved. That is, the remaining items are the monitoring object items whose values are out of the criterion range after the changed items are changed.

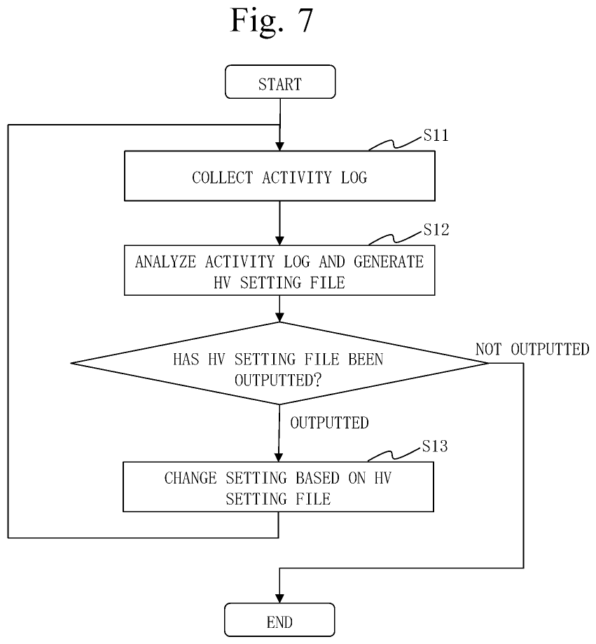

With reference to FIG. 7, general operation of the setting changing system 1 according to Embodiment 1 will be described.

(Step S11: Log Collection Process)

The log collection unit 251 of the information processing device 20 uses the logging tool 28 to collect the activity log for a criterion period concerning each guest OS 26 that operates on the information processing device 20.

In Embodiment 1, the monitoring object log on each of the plurality of monitoring object items set in the monitoring object table 131 and the factor candidate log on each of the plurality of factor candidate items set in the factor candidate table 132 are included in the activity log.

(Step S12: Setting Changing Process)

The setting changing device 10 makes an analysis of a state of the information processing device 20 based on the activity log collected in step S11. In case where the setting changing device 10 determines, as a result of the analysis, that the setting of the hypervisor 25 needs to be changed, the setting changing device 10 outputs an HV setting file indicating contents of the setting to be changed. On the other hand, in case where it is determined, as a result of the analysis, that the setting of the hypervisor 25 does not need to be changed, the HV setting file is not outputted.

In case where the HV setting file has been outputted, the processing is advanced to step S13. On the other hand, in case where the HV setting file has not been outputted, the processing is ended.

(Step S13: Setting Reflection Process)

The setting application unit 252 of the information processing device 20 changes the setting of the hypervisor 25, based on the HV setting file outputted in step S12. Specifically, the setting application unit 252 changes an amount of assignment of the hardware to at least any of the guest OSs 26.

After that, the processing is returned to step S11 and execution is carried out afresh from collection of the activity log.

Incidentally, the processes illustrated in FIG. 7 may be made to be executed afresh upon elapse of a given period of time after ending of the processes.

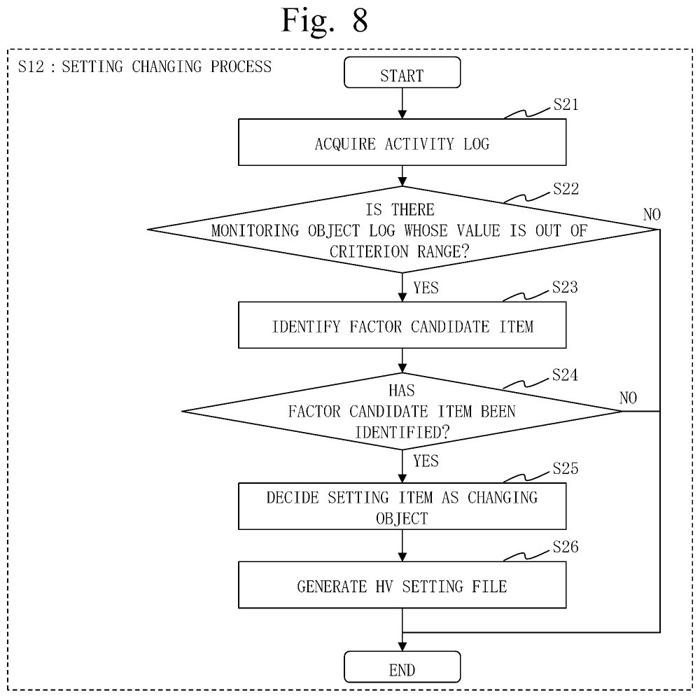

With reference to FIG. 8, the setting changing process (step S12 of FIG. 7) according to Embodiment 1 will be described.

(Step S21: Log Acquisition Process)

The log acquisition unit 111 of the setting changing device 10 acquires the activity log collected in step S11. The log acquisition unit 111 aligns the acquired activity log in time-series. On this occasion, the log acquisition unit 111 may separately align the monitoring object log and the factor candidate log in time-series.

(Step S22: Abnormality Determination Process)

The factor identification unit 112 determines whether the monitoring object log whose value is out of the criterion range is included in the monitoring object log acquired in step S21 or not.

In case where the monitoring object log whose value is out of the criterion range is included, the processing is advanced to step S23. On the other hand, in case where the monitoring object log whose value is out of the criterion range is not included, the processing is ended without output of the HV setting file.

Herein, there is a case in which, after the setting of the hypervisor 25 is changed in step S13 of FIG. 7, the processing is returned to step S11 and step S12 is executed. In this case, the factor identification unit 112 writes information as the remaining items of a record added lastly to the result table 133. In case where the monitoring object log whose value is out of the criterion range is included, specifically, the monitoring object items corresponding to the monitoring object log whose value is out of the criterion range are written as the remaining items. On the other hand, in case where the monitoring object log whose value is out of the criterion range is not included, “ABSENT” is written as the remaining items. The term “ABSENT” means that the monitoring object items to be improved are absent.

(Step S23: Factor Identification Process)

The factor identification unit 112 identifies the factor candidate item for which a difference between a value indicated by the factor candidate log in a normal state in which the value indicated by the monitoring object log acquired in step S21 is within the criterion range and a value indicated by the factor candidate log in an abnormal state in which the value indicated by the monitoring object log acquired in step S21 is out of the criterion range exceeds the threshold.

Specifically, the factor identification unit 112 calculates an average of the values indicated by the factor candidate log in the normal state for each of the factor candidate items. The factor identification unit 112 calculates an average of the values indicated by the factor candidate log in the abnormal state for each of the factor candidate items. The factor identification unit 112 calculates a difference between the average in the normal state and the average in the abnormal state for each of the factor candidate items. Then the factor identification unit 112 identifies the factor candidate item for which the difference exceeds the threshold set for the factor candidate table 132.

(Step S24: Factor Determination Process)

The factor identification unit 112 determines whether the factor candidate item has been identified or not in step S23.

In case where the factor candidate item has been identified, the processing is advanced to step S25. On the other hand, in case where the factor candidate item has not been identified, the processing is ended without output of the HV setting file.

(Step S25: Item Decision Process)

The setting changing unit 113 decides the setting item, assigned to the factor candidate item identified in step S23, as a changing object item. That is, the setting changing unit 113 decides the setting item, set in the factor candidate table 132 in correspondence to the factor candidate item identified in step S23, as the changing object item.

On this occasion, the setting changing unit 113 adds a record to the result table 133. Then the setting changing unit 113 writes the monitoring object item, corresponding to the monitoring object log whose value is out of the criterion range, as an improvement object for the added record. In addition, the setting changing unit 113 writes the setting item, decided as the changing object item, as the changed item for the added record.

(Step S26: Setting File Generation Process)

The setting changing unit 113 generates the HV setting file in which a value of the setting item decided as the changing object item in step S25 has been changed. Specifically, the setting changing unit 113 generates the HV setting file in which the assignment of the hardware decided as the changing object item has been increased. Then the setting changing unit 113 outputs the HV setting file to the information processing device 20.

With reference to FIGS. 4 and 5, an example of the operation of the setting changing device 10 according to Embodiment 1 will be described.

It is assumed that the monitoring object table 131 and the factor candidate table 132 are set as represented in FIGS. 4 and 5. It is assumed that task periodicity of a guest OS 26 is then deviated temporarily from within the criterion range. It is also assumed that a difference between the CPU utilization in the normal state in which the task periodicity of the guest OS 26 is within the criterion range and the CPU utilization in the abnormal state in which the task periodicity of the guest OS 26 is out of the criterion range is greater than 10%.

In this case, the setting changing device 10 determines that the CPU utilization relates to the task periodicity. Then the setting changing device 10 sets CPU core, which is the setting item assigned to the CPU utilization, as the changing object item and increases the assignment of the CPU core to the guest OS 26.

### Effects of Embodiment 1

As described above, the setting changing device 10 according to Embodiment 1 changes the value of the setting item assigned to the factor candidate item whose difference in the value indicated by the factor candidate log between the case where the value indicated by the monitoring object log for the monitoring object item is within the criterion range and the case where the value is out of the criterion range exceeds the threshold. Thus the setting of the hypervisor that makes it possible to bring the monitoring object item within the criterion range is enabled.

Adequate setting of the hypervisor in which the real-time performance of the guest OS 26 is considered can be attained by specification of the item concerning the real-time performance of the guest OS 26 as the monitoring object item.

*** Other Configurations ***

<Modification 1>

There is a possibility that the values indicated by the monitoring object log for a plurality of monitoring object items may be out of the criterion range in step S22 of FIG. 8. In step S23 of FIG. 8, in this case, the factor identification unit 112 identifies cases in which the value indicated by the monitoring object log for at least any of the monitoring object items is out of the criterion range as the abnormal state and identifies the other cases as the normal state. Then the factor identification unit 112 identifies the factor candidate item for which the difference in the value between the normal state and the abnormal state exceeds the threshold, as with Embodiment 1.

<Modification 2>

In Embodiment 1, the functional components are implemented by software. In Modification 2, however, functional components may be implemented by hardware. As for this Modification 2, differences from Embodiment 1 will be described.

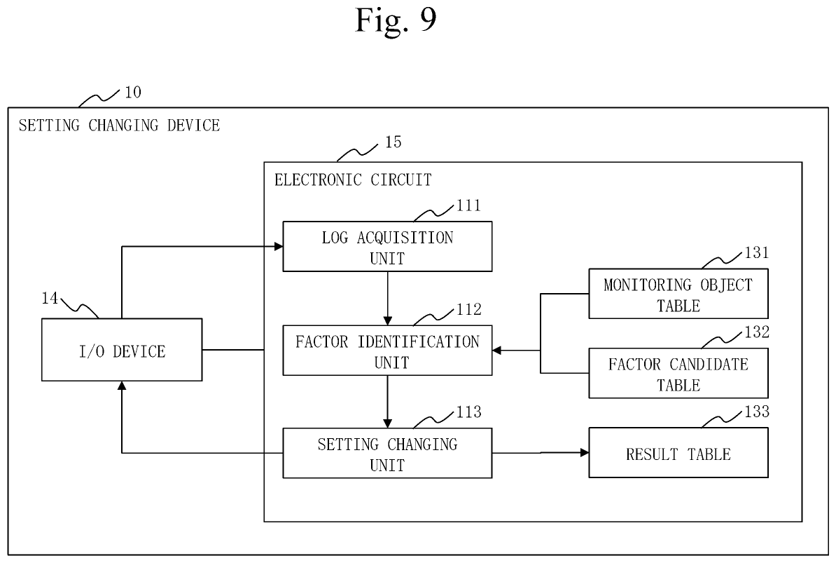

With reference to FIG. 9, a configuration of the setting changing device 10 according to Modification 2 will be described.

In case where the functional components are implemented by hardware, the setting changing device 10 includes an electronic circuit 15 in place of the processor 11, the memory 12, and the storage 13. The electronic circuit 15 is a dedicated circuit that implements the functional components and functions of the memory 12 and the storage 13.

As the electronic circuit 15, a single circuit, a composite circuit, a programmed processor, a parallelly programmed processor, a logic IC, a GA (Gate Array), an ASIC (Application Specific Integrated Circuit), or an FPGA (Field-Programmable Gate Array) can be assumed.

The functional components may be implemented by one electronic circuit 15 or the functional components may be dispersively implemented by a plurality of electronic circuits 15.

<Modification 3>

In Modification 3, some of the functional components may be implemented by hardware and the other functional components may be implemented by software.

The processor 11, the memory 12, the storage 13, and the electronic circuit 15 are referred to as a processing circuit. That is, the functions of the functional components are implemented by the processing circuit.

### Embodiment 2

Embodiment 2 differs from Embodiment 1 in a process in a case where a plurality of factor candidate items have been identified. As for Embodiment 2, this difference will be described and description of identical points is omitted.

*** Description of Operation ***

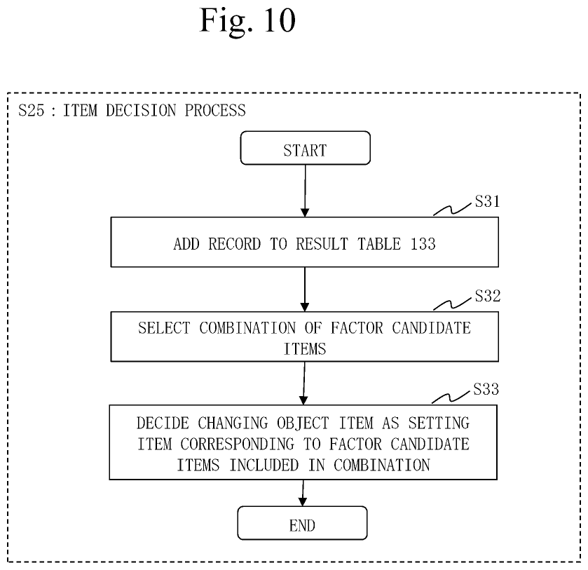

With reference to FIG. 10, operation of the setting changing system 1 according to Embodiment 2 will be described.

An operation procedure of the setting changing device 10 according to Embodiment 2 is equivalent to a setting changing method according to Embodiment 2. Meanwhile, a program that implements the operation of the setting changing device 10 according to Embodiment 2 is equivalent to a setting changing program according to Embodiment 2.

With reference to FIG. 10, an item decision process (step S25 of FIG. 8) according to Embodiment 2 will be described.

(Step S31: Record Addition Process)

The setting changing unit 113 adds a record to the result table 133. Then the setting changing unit 113 writes the monitoring object item, corresponding to the monitoring object log whose value is out of the criterion range, as the improvement object for the added record.

(Step S32: Combination Selection Process)

The setting changing unit 113 selects one or more factor candidate items among the plurality of identified factor candidate items.

Specifically, the setting changing unit 113 refers to the result table 133 to select a combination of one or more factor candidate items that have not been selected for the past criterion period among the plurality of identified factor candidate items.

(Step S33: Item Fixation Process)

The setting changing unit 113 decides the setting item, assigned to each of the factor candidate items included in the combination selected in step S32, as the changing object item. The setting changing unit 113 writes the setting item, decided as the changing object item, as the changed item for the record added in step S31.

### Effects of Embodiment 2

As described above, the setting changing device 10 according to Embodiment 2 selects the combination of the one or more factor candidate items that have not been selected for the past criterion period and decides the changing object items. Thus, even if the plurality of factor candidate items have been identified, the adequate setting of the hypervisor 25 is enabled by iterative execution of the processes of FIG. 7.

The embodiments and modifications of the present disclosure have been described above. Some of these embodiments and modifications of the present disclosure may be embodied in combination. Alternatively, any one or some thereof may be partially embodied. The present disclosure is not limited to the above embodiments and modifications and alterations thereto may be made as appropriate.

### REFERENCE SIGNS LIST

1: setting changing system; 10: setting changing device; 11: processor; 12: memory; 13: storage; 14: I/O device; 111: log acquisition unit; 112: factor identification unit; 113: setting changing unit; 131: monitoring object table; 132: factor candidate table; 133: result table; 20: information processing device; 21: processor; 22: memory; 23: storage; 24: I/O device; 25: hypervisor; 26: guest OS; 27: application software; 28: logging tool; 251: log collection unit; 252: setting application unit; 261: GPOS; 262: RTOS; 30: transmission path

1. A setting changing device comprising:
processing circuitry to:
acquire an activity log concerning an information processing device in which a guest OS (Operating System) operates on a hypervisor, the activity log including a monitoring object log on a monitoring object item and a factor candidate log on each of a plurality of factor candidate items that influence the monitoring object item,
identify a factor candidate item for which a difference between a value indicated by the factor candidate log in a normal state in which a value indicated by the acquired monitoring object log is within a criterion range and a value indicated by the factor candidate log in an abnormal state in which a value indicated by the acquired monitoring object log is out of the criterion range exceeds a threshold, and
decide a setting item, assigned to the identified factor candidate item, as a changing object item.

2. The setting changing device according to claim 1, wherein
in case where a plurality of factor candidate items have been identified, the processing circuitry selects one or more factor candidate items among the plurality of identified factor candidate items and decides a setting item, assigned to the selected factor candidate items as the changing object item.

3. The setting changing device according to claim 2, wherein
the processing circuitry selects a combination of one or more factor candidate items that have not been selected for a past criterion period among the plurality of identified factor candidate items.

4. The setting changing device according to claim 1, wherein
the processing circuitry decides hardware, assigned to the factor candidate item, as the changing object item.

5. The setting changing device according to claim 2, wherein
the processing circuitry decides hardware, assigned to the factor candidate item, as the changing object item.

6. The setting changing device according to claim 3, wherein
the processing circuitry decides hardware, assigned to the factor candidate item, as the changing object item.

7. The setting changing device according to claim 1, wherein
the monitoring object item is an item that influences real-time performance of the guest OS.

8. The setting changing device according to claim 2, wherein
the monitoring object item is an item that influences real-time performance of the guest OS.

9. The setting changing device according to claim 3, wherein
the monitoring object item is an item that influences real-time performance of the guest OS.

10. The setting changing device according to claim 4, wherein
the monitoring object item is an item that influences real-time performance of the guest OS.

11. The setting changing device according to claim 5, wherein
the monitoring object item is an item that influences real-time performance of the guest OS.

12. The setting changing device according to claim 6, wherein
the monitoring object item is an item that influences real-time performance of the guest OS.

13. A setting changing method comprising:
acquiring an activity log concerning an information processing device in which a guest OS (Operating System) operates on a hypervisor, the activity log including a monitoring object log on a monitoring object item and a factor candidate log on each of a plurality of factor candidate items that influence the monitoring object item;
identifying a factor candidate item for which a difference between a value indicated by the factor candidate log in a normal state in which a value indicated by the acquired monitoring object log is within a criterion range and a value indicated by the factor candidate log in an abnormal state in which a value indicated by the acquired monitoring object log is out of the criterion range exceeds a threshold; and
deciding a setting item, assigned to the identified factor candidate item, as a changing object item.

14. A non-transitory computer readable medium storing a setting changing program that causes a computer to function as a setting changing device to execute:
a log acquisition process of acquiring an activity log concerning an information processing device in which a guest OS (Operating System) operates on a hypervisor, the activity log including a monitoring object log on a monitoring object item and a factor candidate log on each of a plurality of factor candidate items that influence the monitoring object item;
a factor identification process of identifying a factor candidate item for which a difference between a value indicated by the factor candidate log in a normal state in which a value indicated by the monitoring object log acquired in the log acquisition process is within a criterion range and a value indicated by the factor candidate log in an abnormal state in which a value indicated by the monitoring object log acquired in the log acquisition process is out of the criterion range exceeds a threshold; and
a setting changing process of deciding a setting item, assigned to the factor candidate item identified in the factor identification process, as a changing object item.
